(19) United States
(12) Patent Application Publication
(10) Pub. No.: US 2019/0164069 A1
(43) Pub. Date: May 30, 2019

(54) METHOD AND SERVER FOR SELECTING RECOMMENDATION ITEMS FOR A USER

(71) Applicant: YANDEX EUROPE AG, Luzern (CH)

(72) Inventors: Dmitry Sergeevich ZHIVOTVOREV, Voronezhskaya obl. (RU); Andrey Petrovich DANILCHENKO, Leningradskaya obl (RU)

(21) Appl. No.: 16/009,929

(22) Filed: Jun. 15, 2018

(30) Foreign Application Priority Data
Nov. 24, 2017 (RU) 2017140971

(51) Int. Cl. G06N 5/04; G06Q 30/06; G06N 99/00

(52) U.S. Cl. CPC G06N 5/04; G06N 99/005; G06Q 30/0631

(57) ABSTRACT

A method and server for selecting recommendation items is provided. The method comprises receiving indication of user accessing a recommendation service. The method comprises determining a user-type of user being one of a new-user and old-user type. The method comprises, responsive to the user being of the new-user type: receiving information associated with a set of items from a landing page of a pre-determined resource being indicative of visual characteristics of the items; generating a feature vector for each item based on information associated with visual characteristics; generating by an MLA a user-non-specific popularity score for each item from based on the respective feature vector; generating a set of user-non-specific recommendation items by selecting from the items user-non-specific recommendation items to be presented to the user; and transmitting the set of user-non-specific recommendation items in lieu of the personalized content recommendation. A method of training the MLA is also provided.

### CROSS-REFERENCE

The present application claims priority to Russian Patent Application No. 2017140971, entitled “Method and Server for Selecting Recommendation Items for a User”, filed Nov. 24, 2017, the entirety of which is incorporated herein by reference.

### FIELD

The present technology relates to recommendation systems in general and, specifically, to a method and apparatus for selecting recommendation items for a user.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

The volume of available information through various Internet resources has grown exponentially in the past couple of years. Several solutions have been developed in order to allow a typical user to find the information that the user is looking for. One example of such a solution is a search engine. Examples of the search engines include GOOGLE™ search engine, YANDEX™ search engine, YAHOO!™ search engine and the like. The user can access the search engine interface and submit a search query associated with the information that the user is desirous of locating on the Internet. In response to the search query, the search engine provides a ranked list of search results. The ranked list of search results is generated based on various ranking algorithms employed by the particular search engine that is being used by the user performing the search. The overall goal of such ranking algorithms is to present the most relevant search results at the top of the ranked list, while less relevant search results would be positioned on less prominent positions of the ranked list of search results (with the least relevant search results being located towards the bottom of the tanked list of search results).

The search engines typically provide a good search tool for a search query that the user knows apriori that she/he wants to search. In other words, if the user is interested in obtaining information about the most popular destinations in Italy (i.e. a known search topic), the user could submit a search query: “The most popular destinations in Italy?” The search engine will then present a ranked list of Internet resources that are potentially relevant to the search query. The user can then browse the ranked list of search results in order to obtain information she/he is interested in as it related to places to visit in Italy. If the user, for whatever reason, is not satisfied with the uncovered search results, the user can re-run the search, for example, with a more focused search query, such as “The most popular destinations in Italy in the summer?”, “The most popular destinations in the South of Italy?”, “The most popular destinations for a romantic getaway in Italy?”.

There is another approach that has been proposed for allowing the user to discover content and, more precisely, to allow for discovering and/or recommending content that the user may not be expressly interested in searching for. In a sense, such systems recommend content to the user without an express search request based on explicit or implicit interests of the user.

An example of such a system is a FLIPBOARD recommending system, which system aggregates and recommends content from various social networks. The FLIPBOARD recommending system presents the uncovered content in a “magazine style” format, where the user can “flip” through the pages with the recommended/aggregated content. The recommending system collects content from social media and other websites, presents it in magazine format, and allows users to “flip” through their social-networking feeds and feeds from websites that have partnered with the company, effectively “recommending” content to the user even though the user may not have expressly expressed her/his desire in the particular content.

Typically, recommendation systems provide personalized content to users based on previous user interactions with the recommendation service that can be indicative of user preferences for some particular content rather than other content. For example, if a user frequently selected sport news articles in the past, such user interactions may be indicative of the user preference for sport news content rather than other content and, based on this user preference, the recommendation system can provide to the user personalized content recommendation that includes comparatively higher proportion of sport news content.

### SUMMARY

Developers of the present technology have appreciated certain technical drawbacks associated with the existing recommendation systems. Conventional recommendation systems usually require at least some “knowledge” about a user in order to provide personalized content thereto. These conventional recommendation systems are faced with the “cold start” problem where the recommendation systems are not able to provide personalized content to new users since very little is “known” about the new users and, therefore, user preferences of these new users for particular content is unknown. The “cold start” problem is even more notable when a recommendation service is expanded onto new territories, regions or countries where it becomes available for the first time to a large pool of new users. This incapacity of recommendation services to provide personalized content to this large pool of new users due to a lack of “knowledge” about their interests, habits or behaviors may slow down, or in some cases, may even stop the expansion of the recommendation service.

It is an object of the present technology to ameliorate at least some of the inconveniences present in the prior art.

At least some embodiments of the present technology may provide a solution to the “cold start” problem of conventional recommendation services. In one embodiment there is provided a recommendation system being able to selectively execute different routines for recommending content to users thereof depending on whether or not the system has enough “knowledge” regarding a given user.

In some cases, if the recommendation system has sufficient “knowledge” about a given user, the recommendation system may be configured to selectively execute a first routine for providing personalized content to the given user.

In at least one embodiment, the recommendation system may be configured to provide the given user with personalized content based on user interests, habits or behaviors that are determined to be associated with the given user.

In other cases, if the recommendation system has insufficient “knowledge” about the given user for providing her/him with personalized content, the recommendation system may be configured to selectively execute a second routine for providing the given user with content that is most likely to be appreciated by a majority of new users.

In at least one other embodiment, the impact of the “cold start” problem on the feasibility of content provision to new users and on their satisfaction with the provided content may be at least partially counteracted by selectively providing new users with content most likely to be appreciated by the majority thereof.

In a first broad aspect of the present technology, there is provided a method of selecting recommendation items to be transmitted to an electronic device associated with a user of a recommendation service. The recommendation service is hosted by a server and the method is executable at the server. The method comprises receiving, by the server, an indication of the user accessing the recommendation service. The method comprises determining, by the server, a user-type of the user of the recommendation service hosted by the server. The user-type is one of a new-user type and an old-user type. The new-user type is associated with users of the recommendation service that are associated with a pre-determined level of previous user interactions with the recommendation service. The pre-determined level of previous user interactions is not sufficient to generate a personalized content recommendation. The method comprises, responsive to the user being of the new-user type, receiving, by the server, information associated with a set of items from a landing page of a pre-determined resource. The information associated with the set of items is indicative of at least visual characteristics of a respective one of the set of items. The landing page of the pre-determined resource comprises pre-selected items of a plurality of items hosted by the pre-determined resource. The method comprises, responsive to the user being of the new-user type, generating, by the server, a feature vector for each one of the set of items from the landing page based on information associated with the visual characteristics of a respective one of the set of items on the landing page. The method comprises, responsive to the user being of the new-user type, generating, by a machine learned algorithm (MLA) executed by the server, a user-non-specific popularity score for each one of the set of items from the landing page based on the respective feature vectors. The MLA has been trained to generate user-non-specific popularity scores for given items based on respective feature vectors and respective user interactions with the given items. The method comprises, responsive to the user being of the new-user type, generating, by the server, a set of user-non-specific recommendation items by selecting from the set of items user-non-specific recommendation items to be presented to the user based on the respective user-non-specific popularity scores. The method comprises, responsive to the user being of the new-user type, transmitting, by the server, the set of user-non-specific recommendation items to the electronic device in lieu of the personalized content recommendation.

In some embodiments of the method, the method may comprise, responsive to the user being of the old-user type, receiving, by the server, previous user interactions of the user with the recommendation service. The method may comprise, responsive to the user being of the old-user type, generating, by the server, a user-specific popularity score for items from a pool of items recommendable by the recommendation service based on the previous user interactions of the user with the recommendation service. The method may comprise, responsive to the user being of the old-user type, generating, by the server, a set of user-specific recommendation items by selecting from the pool of items user-specific recommendation items to be presented to the user based on the respective user-specific popularity scores. The method may comprise, responsive to the user being of the old-user type, transmitting, by the server, the set of user-specific recommendation items as the personalized content recommendation.

In some embodiments of the method, the method may further comprise extracting, by the server, the information associated with the visual characteristics of each one of the set of items from the information associated with the set of items.

In some embodiments of the method, the user-non-specific recommendation items may comprise news items.

In some embodiments of the method, the pre-selected items may have been selected using a resource-native selection algorithm of the pre-determined resource.

In some embodiments of the method, the resource-native selection algorithm may be at least one of a software-based selection algorithm and a human-based selection algorithm.

In some embodiments of the method, the method may comprise the ranking algorithm of the pre-determined resource may rank the plurality of items based on freshness of each of the plurality of items.

In some embodiments of the method, the visual characteristics may comprise at least one of: position of the given item on the landing page; size of the given item on the landing page; and presence of an image associated with the given item on the landing page.

In some embodiments of the method, the visual characteristics may be indicative of a prominence of a respective item on the respective landing page for an operator of the respective resource.

In some embodiments of the method, the generating the set of user-non-specific recommendation items may comprise ranking, by the server, the user-non-specific recommendation items in the set of user-non-specific recommendation items based on a ranking algorithm of the recommendation service.

In some embodiments of the method, the generating the set of user-non-specific recommendation items may comprise excluding, by the server, at least one user-non-specific recommendation item from the set of user-non-specific recommendation items based on a heuristic analysis.

In some embodiments of the method, the excluding the at least one user-non-specific recommendation item from the set of user-non-specific recommendation items based on the heuristic analysis may comprise determining, by the server, that the at least one user-non-specific recommendation item comprises at least one of: violent content; gore content; and sexually-explicit content.

In a second broad aspect of the present technology, there is provided a method of training a machine learned algorithm (MLA) to predict user-non-specific popularity scores of items for a user of a recommendation service. The recommendation service is hosted by a server and the user is of a new-user type. The new-user type is associated with users of the recommendation service that are associated with a pre-determined level of previous user interactions with the recommendation service. The pre-determined level of previous user interactions is not sufficient to generate a personalized user content recommendation. The server implements the MLA and the method comprises receiving, by the server, information associated with a set of items from a landing page of a pre-determined resource. The information associated with the set of items is indicative of at least visual characteristics of a respective one of the set of items. The landing page of the pre-determined resource comprises pre-selected items of a plurality of items hosted by the pre-determined resource. The method also comprises receiving, by the server, an indication of previous user interactions associated with each one of the set of items on the landing page. The method also comprises generating, by the server, a feature vector for each one of the set of items from the landing page based on information associated with the visual characteristics of a respective one of the set of items on the landing page. The method also comprises generating, by the server, a respective training set for each one of the set of items based on the respective feature vector and the respective user interactions. The method also comprises training, by the server, an MLA based on the plurality of training sets to predict a user-non-specific popularity score of a given item. The user-non-specific popularity score is independent from any given user.

In some embodiments of the method, the pre-selected items may have been selected using a resource-native selection algorithm of the pre-determined resource.

In some embodiments of the method, the resource-native selection algorithm may be at least one of a software-based selection algorithm and a human-based selection algorithm.

In some embodiments of the method, the visual characteristics are indicative of a prominence of a respective item on the respective landing page for an operator of the respective resource.

In some embodiments of the method, the method may further comprise predicting, by the MLA implemented by the server, the user-non-specific popularity score of a new item.

In some embodiments of the method, the method may further comprise determining, by the server, whether the new item is to be recommended to the user based on the user non-specific popularity score of the new item.

In a third broad aspect of the present technology, there is provided a server for selecting recommendation items to be transmitted to an electronic device associated with a user of a recommendation service. The recommendation service is hosted by the server that is configured to receive an indication of the user accessing the recommendation service. The server is also configured to determine a user-type of the user of the recommendation service. The user-type is one of a new-user type and an old-user type. The new-user type is associated with users of the recommendation service that are associated with a pre-determined level of previous user interactions with the recommendation service. The pre-determined level of previous user interactions is not sufficient to generate a personalized content recommendation. The server is also configured to, responsive to the user being of the new-user type, receive information associated with a set of items from a landing page of a pre-determined resource. The information associated with the set of items being indicative of at least visual characteristics of a respective one of the set of items. The landing page of the pre-determined resource comprises pre-selected items of a plurality of items hosted by the pre-determined resource. The server is also configured to, responsive to the user being of the new-user type, generate a feature vector for each one of the set of items from the landing page based on information associated with the visual characteristics of a respective one of the set of items on the landing page. The server is also configured to, responsive to the user being of the new-user type generate, by employing a machine learned algorithm (MLA), a user-non-specific popularity score for each one of the set of items from the landing page based on the respective feature vectors. The MLA has been trained to generate user-non-specific popularity scores for given items based on respective feature vectors and respective user interactions with the given items. The server is also configured to, responsive to the user being of the new-user type, generate a set of user-non-specific recommendation items by selecting from the set of items user-non-specific recommendation items to be presented to the user based on the respective user-non-specific popularity scores. The server is also configured to, responsive to the user being of the new-user type, transmit the set of user-non-specific recommendation items to the electronic device in lieu of the personalized content recommendation.

In some embodiments of the server, the server may be configured to, responsive to the user being of the old-user type receive previous user interactions of the user with the recommendation service. The server may be configured to, responsive to the user being of the old-user type, generate a user-specific popularity score for items from a pool of items recommendable by the recommendation service based on the previous user interactions of the user with the recommendation service. The server may be configured to, responsive to the user being of the old-user type, generate a set of user-specific recommendation items by selecting from the pool of items user-specific recommendation items to be presented to the user based on the respective user-specific popularity scores. The server may be configured to, responsive to the user being of the old-user type, transmit the set of user-specific recommendation items as the personalized content recommendation.

In some embodiments of the server, the server may be further configured to extract the information associated with the visual characteristics of each one of the set of items from the information associated with the set of items.

In some embodiments of the server, the set of user-non-specific recommendation items may comprise news items.

In some embodiments of the server, the pre-selected items may have been selected using a resource-native selection algorithm of the pre-determined resource.

In some embodiments of the server, the resource-native selection algorithm may be at least one of a software-based selection algorithm and a human-based selection algorithm.

In some embodiments of the server, the ranking algorithm of the pre-determined resource may rank the plurality of items based on freshness of each of the plurality of items.

In some embodiments of the server, the visual characteristics may comprise at least one of: position of the given item on the landing page; size of the given item on the landing page; and presence of an image associated with the given item on the landing page.

In some embodiments of the server, the visual characteristics may be indicative of a prominence of a respective item on the respective landing page for an operator of the respective resource.

In some embodiments of the server, the server configured to generate the set of user-non-specific recommendation items may comprise the server configured to rank the user-non-specific recommendation items in the set of user-non-specific recommendation items based on a ranking algorithm of the recommendation service.

In some embodiments of the server, the server configured to generate the set of user-non-specific recommendation items may comprise the server configured to exclude at least one user-non-specific recommendation item from the set of user-non-specific recommendation items based on a heuristic analysis.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a system suitable for implementing non-limiting embodiments of the present technology;

FIG. 2 schematically depicts a plurality of resources of the system of FIG. 1 hosting respective pluralities of items in accordance with non-limiting embodiments of the present technology;

FIG. 3 schematically depicts a training sets for training a machine learning algorithm (MLA) implemented by the system of FIG. 1 and generated in accordance with non-limiting embodiments of the present technology;

FIG. 4 depicts a block diagram of a method, the method being executable within the system of FIG. 1 and being implemented in accordance with non-limiting embodiments of the present technology; and

FIG. 5 depicts a block diagram of a method, the method being executable within the system of FIG. 1 and being implemented in accordance with non-limiting embodiments of the present technology.

### DETAILED DESCRIPTION

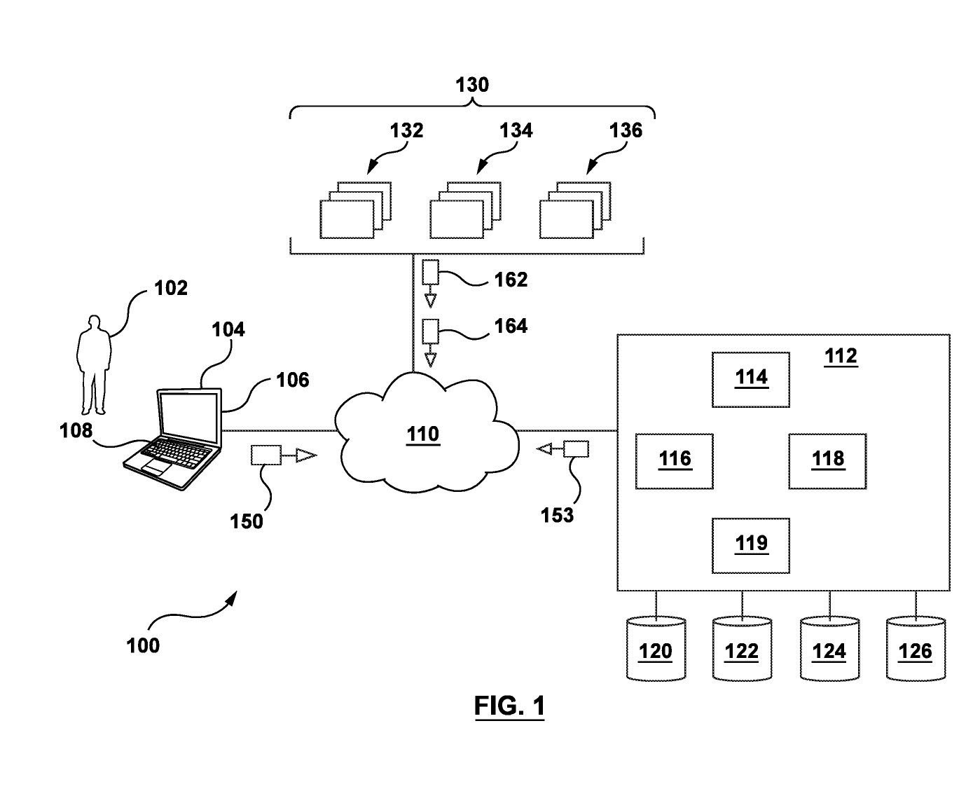

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to provide content recommendations to a user 102 of the system 100 in a form of sets of recommended digital items to be displayed on an electronic device 104 (such as, but not limited to, news articles, retail items, audiovisual items, and the like). The user 102 may be a subscriber to a recommendation service provided by the system 100. However, the subscription does not need to be express or paid for. For example, the user 102 can become a subscriber by virtue of downloading a recommendation application from the system 100, by registering and provisioning a log-in/password combination, by registering and the like. As such, any system variation configured to generate content recommendations for the given user 102 can be adapted to execute embodiments of the present technology, once teachings presented herein are appreciated. Furthermore, the system 100 will be described using an example of the system 100 being a recommendation system (therefore, the system 100 can be referred to herein below as a “recommendation system 100” or a “prediction system 100”). However, embodiments of the present technology can be equally applied to other types of the systems 100, as will be described in greater detail herein below.

The system 100 comprises the electronic device 104, the electronic device 104 being associated with the user 102. As such, the electronic device 104 can sometimes be referred to as a “client device”, “end user device” or “client electronic device”. It should be noted that the fact that the electronic device 104 is associated with the user 102 does not need to suggest or imply any mode of operation—such as a need to log in, a need to be registered, or the like.

The implementation of the electronic device 104 is not particularly limited, but as an example, the electronic device 104 may be implemented as a personal computer (desktops, laptops, netbooks, etc.), a wireless communication device (such as a smartphone, a cell phone, a tablet and the like), as well as network equipment (such as routers, switches, and gateways). The electronic device 104 comprises hardware and/or software and/or firmware (or a combination thereof), as is known in the art, to execute a recommendation application 106. Generally speaking, the purpose of the recommendation application 106 is to enable the user 102 to receive (or otherwise access) recommendation items provided by the system 100. How the recommendation items are selected by the system 100 for the user 102 will be described in greater detail herein below.

How the recommendation application 106 is implemented is not particularly limited. One example of the recommendation application 106 may include a user accessing a web site associated with a recommendation service to access the recommendation application 106. For example, the recommendation application 106 can be accessed by typing in (or otherwise copy-pasting or selecting a link) an URL associated with the recommendation service. Alternatively, the recommendation application 106 can be an app downloaded from a so-called app store, such as APPSTORE™ or GOOGLEPLAY™ and installed/executed on the electronic device 104. It should be expressly understood that the recommendation application 106 can be accessed using any other suitable means.

In other embodiments, the recommendation application 106 may be implemented as a browser (for example, a GOOGLE™ browser, a YANDEX™ browser, a YAHOO!™ browser or any other proprietary or commercially available browser application). For example, the user 102 may be provided access to the recommendation service via a welcome or home page of the browser.

The electronic device 104 is communicatively coupled to a communication network 110 for accessing a server 112. In some non-limiting embodiments of the present technology, the communication network 110 can be implemented as the Internet. In other embodiments of the present technology, the communication network 110 can be implemented differently, such as any wide-area communication network, local-area communication network, a private communication network and the like. A communication link (not separately numbered) between the electronic device 104 and the communication network 110 is implemented will depend inter alia on how the electronic device 104 is implemented.

Merely as an example and not as a limitation, in those embodiments of the present technology where the electronic device 104 is implemented as a wireless communication device (such as a smartphone), the communication link can be implemented as a wireless communication link (such as but not limited to, a 3G communication network link, a 4G communication network link, Wireless Fidelity, or WiFi® for short, Bluetooth® and the like). In those examples where the electronic device 104 is implemented as a notebook computer, the communication link can be either wireless (such as Wireless Fidelity, or WiFi® for short, Bluetooth® or the like) or wired (such as an Ethernet based connection).

The recommendation system 100 also comprises a plurality of resources 130 communicatively coupled to the communication network 110. Each one of the plurality of resources 130, namely a first resource 132, a second resource 134 and a third resource 136, is representative of a network resource accessible by the server 112 through the communication network 110.

For example, the first resource 132 can be a web resource hosting a generally known news web site hosted by the CNN news agency accessible for example at its dedicated URL. In another example, the second resource 134 can be a popular online retail web site hosted by AMAZON online stores accessible for example at its dedicated URL. In yet another example, the third resource 136 can be a web resource hosting a generally known satirical news web site (such as, for example, “The Onion”) accessible for example at its dedicated URL. It should be expressly understood that the first resource 132, the second resource 134 and the third resource 136 can be implemented differently and that a number of additional resources (similar or different to the examples of the first resource 132, the second resource 134 and the third resource 136 provided above) can be present within alternative implementations of the system 100.

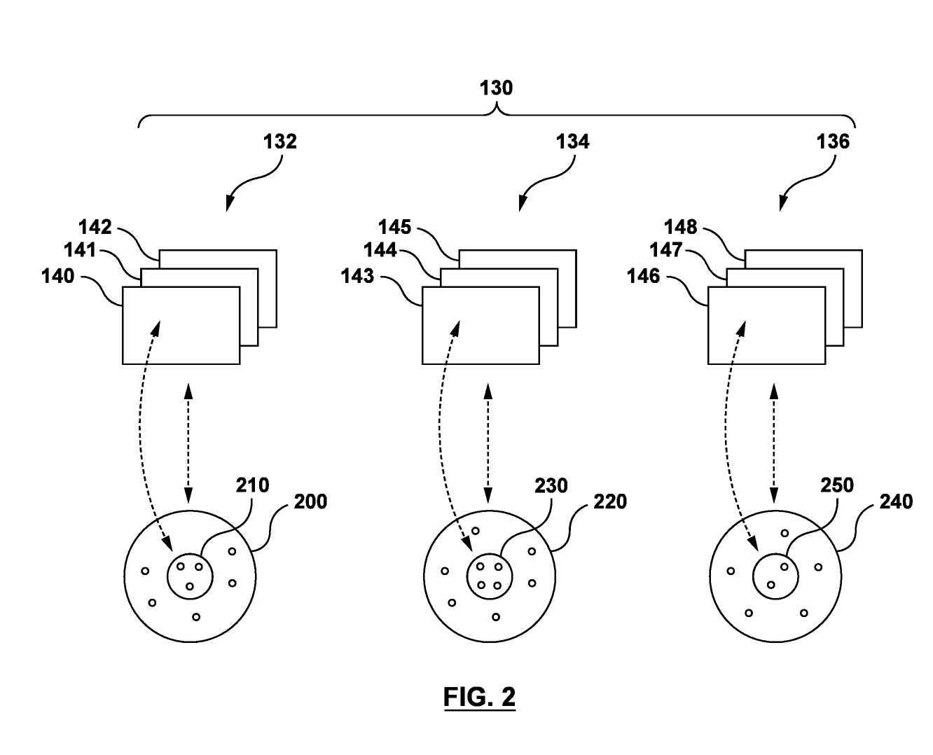

As depicted in FIG. 2, each one of the plurality of resources 130 may host a number of web resources, each of the web resources having one or more “web pages”. Generally speaking, each web resource is associated with a main page or a home page (also known as a “landing page”) of the web resource, which can be typically accessed at a “root” level of the URL (for example, by clicking a hyperlink on another web page, by typing in the URL, etc.). Landing pages are often the most viewed web pages of respective web resources since a large portion of user traffic is generally directed to these landing pages first, before being directed to secondary web pages of the respective web resources.

Let it be assumed that the first resource 132 hosts a first landing page 140 and two secondary web pages 141 and 142, that the second resource 134 hosts a second landing page 143 and two secondary web pages 144 and 145 and that the third resource 136 hosts a third landing page 146 and two secondary web pages 147 and 148. As such, the first landing page 140 may be accessible at the root domain name of the CNN news web portal, the second landing page 143 may be accessible at the root domain name of the Amazon online store web portal and the third landing page 146 may be accessible at the root domain name of the “The Onion” web portal. Although each one of the plurality of resources 130 is depicted as hosting three respective web pages, it should be understood that, in alternative implementations of the plurality of resources 130, any given resource may host less than or more than three respective web pages.

Each one of the plurality of resources 130 also hosts a respective plurality of items. For example, the first resource 132 hosts a plurality of news items 200 that is accessible by users of the first resource 132. A given news item may provide to users of the first resource 132 a news article related to various topics such as, but not limited to, politics, travel, health, entertainment, sports, international affairs and the like.

In another example, the second resource 134 hosts a plurality of retail items 220 that is accessible by users of the second resource 134. A given retail item may provide to users of the second resource 134 product information comprising a price of a product, description of the product, delivery time of the product, rating of the product, images of the product and the like.

In yet another example, the third resource 136 hosts a plurality of satirical news items 240 that is accessible by users of the third resource 136. A given satirical news item may provide to users of the third resource 136 a satirical news article which was written using humor, irony, exaggeration, or ridicule to expose and criticize various contemporary topical issues.

Due to the fact that a large portion of user traffic is directed to landing pages, operators of the respective resources select the items hosted by the respective resources and display pre-selected items hosted by the respective resources on their landing pages in order to increase the likelihood of satisfying the large portion of user traffic accessing the landing pages and, thereby increasing popularity of the respective resources as well as the overall user traffic associated with the respective resources.

Various selection algorithms may be implemented by the respective resources in order to select the respective items hosted thereby. In some embodiments, a given resource-native selection algorithm implemented by a given resource may depend on inter alia a type of items hosted by the given resource and preferences of visitors accessing the given web resource. For example, the first resource 132 may implement a given resource-native selection algorithm that selects the plurality of news items 200 based on “freshness” of news items, which may indicate how fresh or recent a subject of a given news article is. In another example, the second resource 134 may implement a given resource-native selection algorithm that selects the plurality of retail items 220 based on purchase frequency of retail items, which may indicate how desirable a given retail item is. In yet another example, the third resource 136 may implement a given resource-native selection algorithm that selects the plurality of satirical news items 240 based on a number of views of satirical news items, which may indicate how popular a given satirical news item is.

It is contemplated that, in some embodiments of the present technology, a given resource-native selection algorithm may be at least one of a software-based selection algorithm and a human-based selection algorithm. For example, a given software-based selection algorithm may be a given selection MLA having been trained to select top items (such as most fresh items, most popular items, etc.) amongst a given plurality of items hosted by a given resource based on inter alia a type of items hosted by the given resource. In another example, a given human-based selection algorithm may be a human assessor associated with a given pre-determined resource. The given human assessor may be presented with at least some of the given plurality of items hosted by the given pre-determined resource and may select top items (such as most fresh items, most popular items, etc.) to be displayed on a given landing page of the given pre-determined resource.

It is also contemplated that a given resource-native selection algorithm may be a combination of a given software-based selection algorithm and of a given human-based selection algorithm. For example, a given selection MLA may select top items (such as most fresh items, most popular items, etc.) amongst a given plurality of items hosted by a given resource based on inter alia a type of items hosted by the given resource. The so-selected top items by the given selection MLA may be provided to a given human assessor for selecting top items amongst the so-selected top items by the given selection MLA for display on a given landing page of the given resource.

Irrespective of what kind of the specific resource-native selection algorithms being implemented by the respective resources, it can be said that the pre-selected items hosted by the respective resources, which are displayed on the respective landing pages, comprise items that are likely to be considered as being the most relevant for the large portion of the users that accesses the respective landing pages. As such, a set of news items 210 may be displayed on the landing page 140 and which comprises the pre-selected items of the plurality of news items 200. A set of retail items 230 may be displayed on the second landing page 143 and which comprises the pre-selected items of the plurality of retail items 220. A set of satirical news items 250 may be displayed on the third landing page 146 and which comprises the pre-selected items of the plurality of satirical news items 240.

A number of the pre-selected items to be displayed on respective landing pages is not limiting, but just as examples, the set of news items 210 may comprise three items, the set of retail items 230 may comprise four items and the set of satirical news items 250 may comprise two items.

Returning to description of FIG. 1, the recommendation system 100 also comprises the server 112 that can be implemented as a conventional computer server. In an example of an embodiment of the present technology, the server 112 can be implemented as a Dell™ PowerEdge™ Server running the Microsoft™ Windows Server™ operating system. Needless to say, the server 112 can be implemented in any other suitable hardware, software, and/or firmware, or a combination thereof. In the depicted non-limiting embodiments of the present technology, the server 112 is a single server. In alternative non-limiting embodiments of the present technology, the functionality of the server 112 may be distributed and may be implemented via multiple servers.

The server 112 implements a user-type determination algorithm 114, a first machine learned algorithm (MLA) 116, a second MLA 118 and a ranking algorithm 119. The server 112 also has access to a main database 120, an item feature database 122, an recommendable item database 124 and a user interaction database 126.

Furthermore, in the depicted illustration, the main database 120, the item feature database 122, the recommendable item database 124 and the user interaction database 126 are depicted as separate physical entities. This does not need to be so in each and every embodiment of the present technology. As such, some or all of the main database 120, the item feature database 122, the recommendable item database 124 and the user interaction database 126 may be implemented in a single database. Furthermore, any one of the main database 120, the item feature database 122, the recommendable item database 124 and the user interaction database 126 may, in itself, be split into several distributed storages.

By the same token, all (or any combination of) the user-type determination algorithm 114, the first MLA 116, the second MLA 118, the ranking algorithm 119, the main database 120, the item feature database 122, the recommendable item database 124 and the user interaction database 126 may be implemented in a single hardware apparatus.

The main database 120 is configured to store information extracted or otherwise determined by the server 112 during processing. Generally speaking, the main database 120 may receive data from the server 112 that was extracted or otherwise determined by the server 112 during processing for temporary and/or permanent storage thereof and may provide stored data to the server 112 for use thereof.

The item feature database 122 is configured to store information related to item features associated with, for example, items that were previously recommended by the recommendation service to its previous users and with which at least one previous user has interacted. Examples of such items can include but are not limited to: a song to be streamed or downloaded, a document to be downloaded, a news article to be read, a product being sold, a Search Engine Result Page (SERP) and the like.

Examples of the item features include but are not limited to:
popularity of a given item amongst users of the recommendation service (for example, in case of the given item being a music track, how many times this given music track has been listened to/downloaded by users of the recommendation service);
a number of likes/purchases/downloads/clicks amongst all events associated with the given item and that have been performed via the recommendation service; and
item-inherent characteristics—in case of the given item being a music track—length of the track, the genre of the track, audio-characteristic of the track (for example, tempo of the track); other item-inherent characteristics include: the price of the given item, the dimensions of the given item, the category of the given item, the producer/maker of the item, the length of the document measured in words or symbols; category/theme of the document; movie rating on a movie rating host, etc.

The recommendable item database 124 is configured to store information related to a pool of potentially recommendable items by the recommendation service and that comprises all the items that the recommendation service can potentially recommend to its users. Each one of the pool of potentially recommendable items is a respective digital item associated with respective item features being stored in the item feature database 122. The nature of one or more potentially recommendable items within the pool of recommendable items is not particularly limited. Some examples of the one or more potentially recommendable items include but are not limited to digital items such as:
a news item;
a publication;
a web resource;
a post on a social media web site;
a new item to be downloaded from an application store;
a new song (music track) to play/download from a resource;
a new movie (video clip) to play/download from a resource;
a product to be bought from a resource; and
a new document uploaded for viewing on a social media web site (such as a new photo uploaded to an INSTRAGRAM or FACEBOOK account).

The pool of potentially recommendable items can comprise at least one item from the plurality of news items 200, the plurality of retail items 220 and the plurality of satirical news items 240, even though this does not need to be the case in each and every embodiment of the present technology.

The user interaction database 126 is configured to store information related to user events/interactions associated with previous users of the system 100. Naturally, the user events can be stored in an encrypted form. Examples of the user events include but are not limited to:
a given user of the recommendation system “scrolled over” a given item;
a given user of the recommendation system “liked” the given item;
a given user of the recommendation system shared the given item;
a given user of the recommendation system has clicked on (or otherwise selected) the given item; and
a given user of the recommendation system has purchased/ordered/downloaded the given item.

It should be expressly understood that the user events and the item features may take many forms and are not specifically limited. As such, above presented lists of non-limiting examples of the way that the user events and the item features may be implemented are just examples thereof. As such, it should be expressly understood that many other alternative implementations of the user events and the item features may be contemplated in different implementations of the present technology.

How information is obtained and stored in the item feature database 122, the recommendable item database 124 and the user interaction database 126 is not particular limited.

For example, the information related to the item features may be obtained from a particular service that maintains information about various items available therefrom and the like; and stored in the item feature database 122. The information related to the item features may be divided into various categories representative of various types or topics of items.

In another example, the information related to the set of potentially recommendable items can be obtained by “crawling” a large variety of resources which may include, in some cases, the plurality of resources 130; and stored in the recommendable item database 124. However, it is contemplated that the set of potentially recommendable items may not include any one of or some of the items amongst the plurality of news items 200, the plurality of retail items 220 and the plurality of satirical news items 240.

In yet another example, the information related to the user events may be obtained by collecting recording previous user interactions between any one of the set of potentially recommendable items stored in the recommendable item database 124 and all the users of the recommendation system; and stored in the user interaction database 126. The information related to the user events may be stored in an encrypted form.

The server 112 hosts the recommendation service and, generally speaking, is configured to (i) receive from the electronic device 104 a request 150 for recommended content and (ii) responsive to the request 150, generate a response 153 comprising a given set of recommendation items. As it will be further described herein below, the given set of recommendation items transmitted to the electronic device 104 may be, in some implementations, user-specific and therefore will represent a personalized content recommendation that is specific to the user 102 or, in other implementations, user-non-specific and therefore will represent a non-personalized content recommendation that is not specific to the user 102.

In some embodiments of the present technology, the request 150 may be generated in response to the user 102 providing an explicit indication of a user desire to receive recommended content such as by clicking a button from the recommendation application 106. Therefore, the request 150 for a given set of recommendation items can be thought of as “an explicit request” in a sense of the user 102 expressly providing a request for the given set of recommendation items.

In other embodiments, the request 150 can be generated in response to the user 102 providing an implicit indication of the user desire to receive recommended content. In some embodiments of the present technology, the request 150 can be generated in response to the user 102 starting the recommendation application 106.

In yet further embodiments of the present technology, the request 150 can be generated even without the user 102 providing either explicit or implicit indication of the user desire to receive recommended content. For example, in those embodiments of the present technology where the recommendation application 106 is implemented as the browser, as previously mentioned, the request 150 can be generated in response to the user 102 opening the browser application and can be generated, for example, without the user 102 executing any additional actions other than activating the browser application. As another example, the request 150 can be generated in response to the user 102 opening a new tab of the already-opened browser application and can be generated, for example, without the user 102 executing any additional actions other than activating the new browser tab. In other words, the request 150 can be generated even without the user 102 knowing that the user 102 may be interested in obtaining the given set of recommendation items.

As another example, the request 150 may be generated in response to the user 102 selecting a particular element of the browser application and can be generated, for example, without the user 102 executing any additional actions other than selecting/activating the particular element of the browser application.

Examples of the particular element of the browser application include but are not limited to:
an address line of the browser application bar;
a search bar of the browser application and/or a search bar of a search engine web site accessed in the browser application;
an omnibox (combined address and search bar of the browser application);
a favourites or recently visited network resources pane; and
any other pre-determined area of the browser application interface or a web resource displayed in the browser application.

Upon receiving the request 150 from the electronic device 104 via the communication network 110, the server 112 is configured to execute the user-type determination algorithm 114 for determining a user-type of the user 102. The user-type of a given user of the recommendation service hosted by the server 112 may be one of a new-user type and an old-user type.

Generally speaking, a given user of the recommendation service being of the old-user type means that the given user is an “old” user of the recommendation service such that the given user has had enough previous interactions with the recommendation service to enable the server 112 to collect enough indications of previous user interactions associated with the given user and, thus, to enable the server 112 to generate user-specific content recommendations for the given user. The indications of previous user interactions associated with the given user are stored in the user interaction database 126 and can be retrieved by the server 112 for further processing.

Conversely, a given user of the recommendation service may be a “new” user, in the sense that she/he has had limited previous interactions, or no previous interactions at all, with the recommendation service. This means that the server 112 was unable to collect enough indications of previous user interactions associated with this “new” user and, thus, the recommendation service does not have sufficient information to generate user-specific content recommendations for this “new” user. The given user may be of the new-user type if she/he is associated with limited (or with no) previous user interactions that are stored in the user interaction database 126.

It should be understood that, the recommendation service hosted by the server 112 may require at least a scintilla of “knowledge” about a given user's preferences, habits or behaviors in order to provide a personalized content recommendation to the given user. Indeed, the recommendation service may not be able to generate or otherwise select user-specific recommendations if the recommendation service does not know a priori at least some information about the given user. This is known as a “cold start” problem of recommendation services which refers to a situation when a given recommendation service “knows” very little about the new user accessing it and, therefore, lacks the necessary information for generating or otherwise selecting a personalized content recommendation that is user-specific to the new user.

It is contemplated that, in some embodiments of the present technology, the server 112 may be configured to selectively execute different routines depending on whether the user 102 is of the new-user type or of the old-user type in order to recommend items to the user 102.

Upon execution of the user-type determination algorithm 114, the server 112 is configured to receive information associated with the previous user interactions associated with the user 102 from the user interaction database 126 for determining whether or not the user 102 is associated with a pre-determined level of previous user interactions. The pre-determined level of previous user interactions has been determined as any given amount of previous user interactions that is not sufficient for generating a personalized content recommendation.

In some embodiments, the pre-determined level of previous user interactions may be determined by an operator of the recommendation service. In other embodiments, the pre-determined level of previous user interactions may be determined by the server 112 based on an analysis of user satisfaction with previous provisions of personalized content recommendations and amounts of previous user interactions associated with these users during generation of these respective personalized content recommendations.

Irrespective of how the pre-determined level of previous user interactions has been determined, if the server 112 determines that an amount of previous user interactions associated with the user 102 does not correspond to the pre-determined level of previous user interactions, the server 112 determines that the user 102 is of the old-user type. Conversely, If the server 112 determines that the amount of previous user interactions associated with the user 102 corresponds to the pre-determined level of previous user interactions, the server 112 determines that the user 102 is of the new-user type.

### Processing of Recommended Content for an Old-User Type User

Let it be assumed that the server 112 determines that the amount of previous user interactions associated with the user 102 does not correspond to the pre-determined level of previous user interactions. Therefore, the server 112 determines that the user 102 is of the old-user type. Responsive to the user 102 being of the old-user type, the server 112 may execute a routine for providing a personalized content recommendation to the user 102. To that end, the server 112 may employ the second MLA 118 for generating a user-specific popularity score for at least some items of the pool of potentially recommendable items stored in the recommendable item database 124.

The second MLA 118 may be configured to generate a set of user-specific recommendation items by selecting, from the pool of potentially recommendable items, user-specific recommendation items based on the user-specific popularity scores generated by the server 112. For example, the second MLA 118 may select top ranked items from the pool of potentially recommendable items based on the user-specific popularity scores as user-specific recommendation items to be presented to the user 102.

How the second MLA 118 of the server 112 is trained and configured to generate the user-specific popularity scores and how the second MLA 118 is configured to select the set of user-specific recommendation items from the pool of potentially recommendable items to be presented to the user 102 is disclosed in a patent application Ser. No. 15/607,555, filed on May 29, 2017 and entitled “METHOD AND APPARATUS FOR TRAINING A MACHINE LEARNING ALGORITHM (MLA) FOR GENERATING A CONTENT RECOMMENDATION IN A RECOMMENDATION SYSTEM AND METHOD AND APPARATUS FOR GENERATING THE RECOMMENDED CONTENT USING THE MLA”, the entirety of which is incorporated herein by reference.

The server 112 may also be configured to transmit the set of user-specific recommendation items as the personalized content recommendation to the electronic device 104 for presentation to the user 102 via the recommendation application 106.

In some embodiments, prior to transmitting the set of user-specific recommendation items as the personalized content recommendation, the server 112 may execute the ranking algorithm 119 (see FIG. 1) for ranking user-specific recommendation items in a given set of user-specific recommendation items. In other words, after selecting the user-specific recommendation items, the server 112 may rank the user-specific recommendation items via the ranking algorithm 119.

Generally speaking, the ranking algorithm 119 may be implemented to “control” the order of presentation or display of recommendation content to the user 102 in the recommendation application 106. For example, the ranking algorithm 119 may have been trained to rank items in a given set of recommendation items based on the window size and/or display settings of the recommendation application 106. As such, by ranking the recommendation content via the ranking algorithm 119, the recommendation content may be ranked such that it is displayed in the recommendation application 106 on the electronic device 104 in a visually-appealing manner for the user 102.

The server 112 can generate a data packet, such as the response 153, which in this case comprises information indicative of the set of user-specific recommendation items. The server 112 may transmit the response 153 to the electronic device 104 via the communication network 110 for triggering the display of the personalized content recommendation to the user 102.

### Processing of Recommended Content for a New-User Type User

Now let it be assumed that the server 112 determines that the amount previous user interactions associated with the user 102 corresponds to the pre-determined level of previous user interactions. Therefore, the server 112 determines that the user 102 is of the new-user type. Indeed, since the amount of previous user interactions associated with the user 102, which are retrieved from the user interaction database 126, corresponds to the pre-determined level of previous user interactions, the previous user interactions of the user 102 with the recommendation service are not sufficient to generate a personalized content recommendation for the user 102 (i.e., the very situation referred to above as the “cold start” problem of recommendation services). Therefore, in lieu of the personalized content recommendation, the server 112 may provide to the user 102 a given set of user-non-specific recommendation items that includes items that are selected in a user-non-specific manner.

In accordance with the non-limiting embodiments of the present technology, since the server 112 lacks necessary information to provide the user 102 with a personalized content recommendation, the server 112 may be configured to provide items to the user 102 that originate from landing pages of resources that are considered as “trustworthy” by the operator of the server 112. Generally speaking, the operator may determine a given set of pre-determined resources that she/he considers as “trustworthy” in providing content that will most likely be appreciated by a majority of new users.

For example, the operator of the server 112 may determine that, amongst the plurality of resources 130, the first resource 132 and the second resource 134 are “trustworthy” resources and provide content on their respective first and second landing pages 140 and 143 that will most likely be appreciated by to the majority of new users irrespective of any given new user's personal preference for recommended content. In a sense, the generation of the content recommendation in accordance with the non-limiting embodiments of the present technology acts as a “best approximation” of personalized content that could be otherwise recommended to the user if the user were an old-user type user. In another example, the operator of the server 112 may determine that, amongst the plurality of resources 130, the third resource 136 is not a “trustworthy” resource for providing content that will most likely be appreciated by the majority of new users.

In other words, the operator may determine that content provided on the first landing page 140 of the first resource 132 is most likely to be appreciated by the majority of new users since the first resource 132 is a generally known news website providing news articles that are renowned for being of a good quality.

Similarly, the operator may determine that content provided on the second landing page 143 of the second resource 134 is most likely to be appreciated by the majority of new users since the second resource 134 is a popular online retail web site selling retail items and which has a good reputation with their clients.

However, the operator may determine that content provided by the third resource 136 is likely not to be appreciated by the majority of new users since the third resource 136 is a generally known satirical news web site providing satirical news articles which are appreciable only by a smaller group of users.

As a result, the server 112 may be configured to provide the user 102 being of the new-user type with a given set of user-non-specific recommendation items that comprises items originating from landing pages of a set of pre-determined “trustworthy” resources which, in this case, may comprise the first resource 132 and the second resource 134. It is contemplated that the given set of user-non-specific recommendation items may comprise items originating from other landing pages of other pre-determined resources that have been determined as being “trustworthy”.

It should be noted that, although the third resource 136 is not considered as “trustworthy” by the operator of the server 112 for providing content that will most likely be appreciated by the majority of new users, as previously mentioned, at least some items of the plurality of satirical news items 240 hosted by the third resource 136 may be stored in the recommendable item database 124 and provided to some users of the recommendation service that are of the old-user type.

As such, responsive to the user 102 being of the new-user type, in order to provide the user 102 with at least some items originating from at least one landing page of at least one pre-determined resource having been determined to be a “trustworthy” resource, the server 112 may be configured to employ the first MLA 116. During the in-use phase of the first MLA 116, the first MLA 116 may be employed by the server 112 in order to predict user-non-specific popularity scores for items originating from the at least one landing page of the at least one pre-determined resource. To that end, the first MLA 116 is trained to predict user-non-specific popularity scores for given items during a training phase. How the first MLA 116 is trained to predict user-non-specific popularity scores of given items during the training phase thereof will now be described.

### Training

During the training phase of the first MLA 116, the server 112 may receive information associated with landing pages of “trustworthy” resources. In the example depicted herein, the server 112 may receive information associated with the first landing page 140 of the first resource 132 which has been determined to be a “trustworthy” resource and the second landing page 143 of the second resource 134 which has also been determined to be a “trustworthy” resource. It is contemplated that the server 112 may receive information associated with landing pages of other pre-determined resources that have been determined to be “trustworthy” resources.

For example, the server 112 may be configured to receive computer files representative of the first and second landing pages 140 and 143, which may be written in Hypertext Markup Language (HTML) or in any other suitable markup language, as well as computer files representative of the web resource elements (such as, but not limited to, style sheets, scripts, images and the like) that are associated with the computer files representative of the first and second landing pages 140 and 143.

In addition, the server 112 is configured to receive indications of user interactions associated with the first and second landing pages 140 and 143. User interactions associated with the first and second landing pages 140 and 143 are user interactions that have been previously performed by visitors on the first and second landing pages 140 and 143. Types of these user interactions are not limiting, however, just as some examples, these user interactions may be clicks, long clicks, hovering, scrolling, and other actions such as downloading, purchasing, sharing and the like.

To that end, the server 112 may be configured to receive a first data packet 162 from the first resource 130 and a second data packet 164 from the second resource 134. The first data packet 162 comprises (i) information associated with the first landing page 140 and (ii) indications of user interactions associated with the first landing page 140. The second data packet 164 comprises (i) information associated with the second landing page 143 and (ii) indications of user interactions associated with the second landing page 143.

Recalling that the first landing page 140 hosts the set of news items 210 being the top ranked items of the plurality of news items 200, the information associated with the first landing page 140 comprises information associated with the set of news items 210 and indications of user interactions associated with the first landing page 140 comprise indications of user interactions associated with the set of news items 210. Also, recalling that the second landing page 143 hosts the set of retail items 230 being the top ranked items of the plurality of retail items 220, the information associated with the second landing page 143 comprises information associated with the set of retail items 230 and indications of user interactions associated with the second landing page 143 comprise indications of user interactions associated with the set of retail items 230.

In some embodiments, upon receiving the first data packet 162, the server 112 may be configured to parse the content thereof in order to extract information associated with visual characteristics of the set of news items 210 and the indications of user interactions with the set of news items 210. Also, upon receiving the second data packet 164, the server 112 may be configured to parse the content thereof in order to extract the information associated with visual characteristics of the set of retail items 230 and the indications of user interactions with the set of news items 230.

Generally speaking, parsing refers to execution of syntactic and/or lexical analyses of computer codes for facilitating extraction of particular components and/or other semantic information from the computer codes. During parsing, a parsing algorithm may be employed by the server 112 and may be inputted with computer files for outputting or building data structures, in a form of parse trees, abstract syntax trees or other hierarchical structures, which define structural representations of the inputted computer files. Inputted computer files may be written in various computer languages such as markup languages, for example.

The visual characteristics of a given item may comprise, but are not limited to, a position of the given item on the respective landing page, a size of the given item on the respective landing page, a relative size of the given item with respect to other items on the respective landing page, a presence of an image and/or of a video associated with the given item on the respective landing page, fonts of textual information associated with the given item on the respective landing page, and the like. It is contemplated that the visual characteristics of a given item may be indicative of a prominence of the given item on the landing page for the operator of the respective resource.

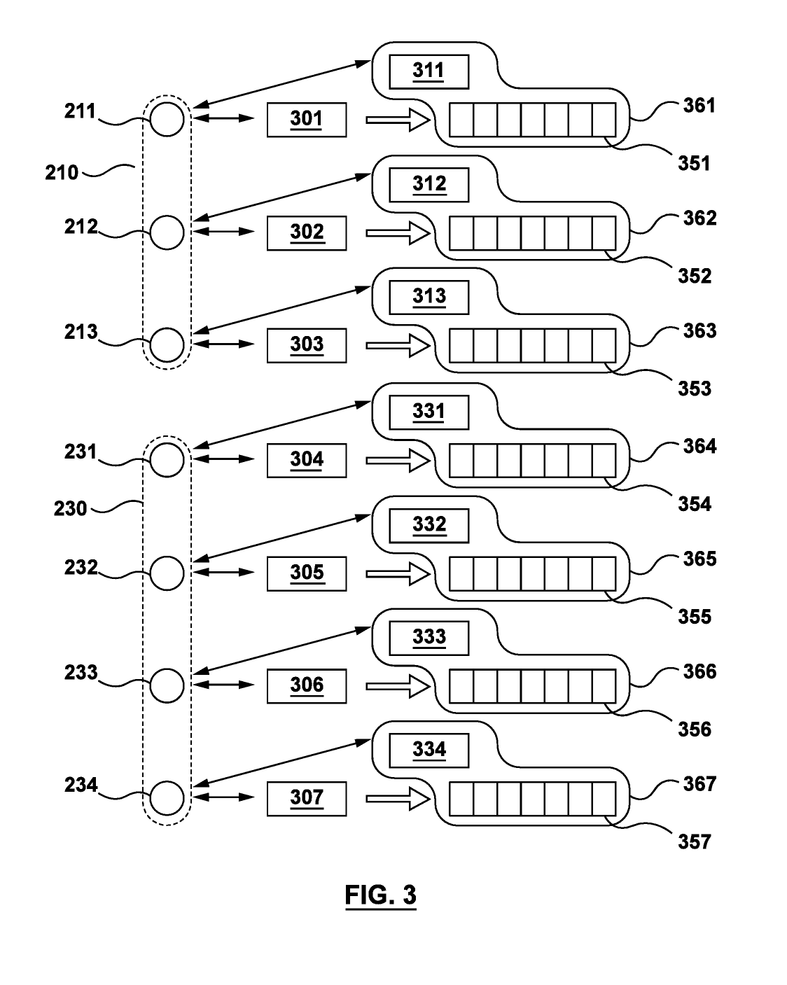

With reference to FIG. 3, the server 112 extracts from the content of the first data packet 162 visual characteristics data 301, 302 and 303, which is the information associated with visual characteristics of three news items 211, 212 and 213 (i.e. the set of news items 210), as well as item-interaction data 311, 312 and 313, which are indications of user interactions associated with the news items 211, 212 and 213 performed by visitors of the first landing page 140.

Also, the server 112 extracts from the content of the second data packet 164 visual characteristics data 304, 305, 306 and 307, which is the information associated with visual characteristics of four retail items 231, 232, 233 and 234 (i.e. the set of news items 210), as well as item-interaction data 331, 332, 333 and 334, which are indications of user interactions associated with the retail items 231, 232, 233 and 234 performed by visitors of the second landing page 143.

Thus, the server 112 extracts from the content of the first and the second data packets 162 and 164:
item-interaction data 311 and visual characteristics data 301 associated with the news item 211;
item-interaction data 312 and visual characteristics data 302 associated with the news item 212;
item-interaction data 313 and visual characteristics data 303 associated with the news item 213;
item-interaction data 331 and visual characteristics data 304 associated with the retail item 231;
item-interaction data 332 and visual characteristics data 305 associated with the retail item 232;
item-interaction data 332 and visual characteristics data 306 associated with the retail item 233; and
item-interaction data 334 and visual characteristics data 307 associated with the retail item 234.

In some embodiments of the present technology, the server 112 may be configured to store the content of the first and second data packets 162 and 164 in the main database 120 for further use thereof. In other embodiments, the server 112 may be configured to store for each given item the respective item-interaction data and the respective visual characteristics data that were extracted from the first and the second data packets 162 and 164 in the main database 120 for further use thereof.

During the training phase of the first MLA 116, the server 112 is configured to generate a given feature vector for each one of the set of news items 210 and each one of the set of retail items 230 based on the information associated with visual characteristics of a respective one of the set of news items 210 and with visual characteristics of a respective one of the set of retail items 230. In other words, the server 112 is configured to generate a feature vector for each given item based on the respective visual characteristics data.

Thus, the server 112 can generate:
a feature vector 351 for the news item 211 based on the visual characteristics data 301;
a feature vector 352 for the news item 212 based on the visual characteristics data 302;
a feature vector 353 for the news item 213 based on the visual characteristics data 303;
a feature vector 354 for the retail item 231 based on the visual characteristics data 304;
a feature vector 355 for the retail item 232 based on the visual characteristics data 305;
a feature vector 356 for the retail item 233 based on the visual characteristics data 306;

and
a feature vector 357 for the retail item 234 based on the visual characteristics data 307.

In some embodiments of the present technology, the server 112 may be configured to store for each item amongst the set of news items 210 and the set of retail items 230 the respective feature vector in the main database 120 for further use thereof.

It should be noted that each feature vector is generated by the server 112 based on the information associated with the visual characteristics of a respective item. For example, at least one dimension of the given feature vector may be associated with a first visual characteristic of the respective item (such as the size thereof on the respective landing page), while at least one other dimension of the given feature vector may be associated with another visual characteristic of the respective item (such as the position thereof on the respective landing page).

As previously mentioned, various visual characteristics may be indicative of a prominence of a given item on a respective landing page for the operator of the respective resource. In one example, if a given item has a given size on the respective landing page, this may be indicative that the given item has a lower prominence for the operator of the respective resource in comparison to another given item on the respective landing page having a larger size than the given size of the given item.

In other embodiments of the present technology, it is contemplated that a given feature vector may be generated, not only based on the information associated with the visual characteristics of a respective item, but also based on other information associated with the respective item without departing from the scope of the present technology. This other information associated with the respective item could be extracted from the content of the first data packet 162 and/or the second data packet 164. Therefore, it can be said that in other embodiments of the present technology, a given feature vector may be based at least on the information associated with the visual characteristics of a respective item.

Returning to the description of the training phase of the first MLA 116, the server 112 is also configured to generate a respective training set for each one of the set of news items 210 and each one of the set of retail items 230 based on the respective feature vectors and the respective item-interaction data (having been extracted from the content of the first and the second data packets 162 and 164). In other words, the server 112 is configured to generate for each item a respective training set based on (i) a respective feature vector previously generated and (ii) the respective item-interaction data.

Thus, the server 112 is configured to generate:
a training set 361 based on the feature vector 351 and the item-interaction data 311;
a training set 362 based on the feature vector 352 and the item-interaction data 312;
a training set 363 based on the feature vector 353 and the item-interaction data 313;
a training set 364 based on the feature vector 354 and the item-interaction data 331;
a training set 365 based on the feature vector 355 and the item-interaction data 332;
a training set 366 based on the feature vector 356 and the item-interaction data 333; and
a training set 367 based on the feature vector 357 and the item-interaction data 334.

In some embodiments of the present technology, the server 112 may be configured to store for each item amongst the set of news items 210 and the set of retail items 230 the respective training set in the main database 120 for further use thereof.

The server 112 is then configured to input the training sets 361, 362 363, 364, 365, 366 and 367 into the “untrained” first MLA 116 in order to train the first MLA 116 to predict user-non-specific popularity scores of given items. In other words, the “untrained” first MLA 116 learns, in a sense, relationships and/or data patterns between the visual characteristics of given items on their respective landing pages and their respective user interactions in order to approximate how visual characteristics of the given items “correlate” to user interactions with these items on their respective landing pages.

For example, during the training phase, the first MLA 116 may determine that items associated with sizes that are comparatively larger to sizes of other items on the respective landing pages are generally associated with amounts of user interactions that are comparatively larger to amounts of user interactions associated with the other items on the respective landing pages. In other words, the first MLA 116 may “learn” that the amount of user interactions with given items on the respective landing pages, at least in some cases, may grow with the respective sizes thereof on the respective landing pages.

In another example, during the training phase, the first MLA 116 may determine that items that are positioned higher to other items on the respective landing pages are generally associated with amounts of user interactions that are comparatively larger to amounts of user interactions associated with the other items on the respective landing pages. In other words, the first MLA 116 may “learn” that the amount of user interactions with given items on the respective landing pages, at least in some cases, may grow in-line with the higher positions thereof on the respective landing pages.

### In-Use

Therefore, responsive to the user 102 being of the new-user type, the server 112 is configured to receive information associated with at least one landing page of at least one resource that has been previously determined by the operator of the recommendation service as a “trustworthy” resource. In some embodiments, the server 112 may be configured to receive information associated with the first landing page 140 of the first resource 132 and/or the second landing page 143 of the second resource 134. However, it is contemplated that the server 112 may be configured to receive information associated with any other landing page of any other resource that has been previously determined by the operator of the recommendation service as a “trustworthy” resource.

Upon receiving information associated with the at least one landing page of the at least one resource that has been previously determined by the operator as a “trustworthy” resource, the server 112 is configured to parse this information in order to receive information associated with a given set of items on the at least one landing page.

The server 112 may receive the information associated with the at least one landing page of the at least one resource via respective data packets from each one of the at least one resource, the content of which are analogous to the content of the first data packet 162 and the second data packet 164 received from the first resource 132 and the second resource 134, respectively. It is contemplated, however, that the content of the respective data packets received from each one of the at least one resource may or may not comprise information indicative of user interactions on the at least one landing page.

The server 112 is then configured to generate a respective feature vector for each one of the given set of items of the at least one landing page. The server 112 is configured to generate a respective feature vector for each one of the given set of items of the at least one landing page similarly to how the server 112 is configured to generate the feature vectors 351, 352, 353, 354, 355, 356 and 357. As such, each feature vector of each one of the given set of items of the at least one landing page is based on the information associated with the visual characteristics of the respective item on the respective one of the at least one landing page.

The server 112 is then configured to employ the “trained” first MLA 116 in order to generate a user-non-specific popularity score for each one of the given set of items of the at least one landing page based on the respective feature vectors. For example, if the given set of items of the at least one landing page comprises 25 items, the server 112 may be configured to generate 25 user-non-specific popularity scores where each user-non-specific popularity score is associated with a respective item.

The server 112 may be configured to store information representative of the user-non-specific popularity scores in association with a respective one of the given set of items in the main database 120 for future use thereof.

It should be noted that these user-non-specific popularity scores are non-specific to the user 102 since the server 112 did not use information regarding the user 102 in order to generate these user-non-specific popularity scores.

The server 112 is then configured to generate a set of user-non-specific recommendation items to be presented to the user 102. The server 112 is configured to generate the set of user-non-specific recommendation items by selecting items from the given set of items of the at least one landing page based on the respective user non-specific popularity scores. The server 112 may be configured to rank the items in the given set of items based on their respective user-non-specific popularity scores and may select the top ranked items as the user-non-specific recommendation items.

For example, the server 112 may rank the 25 items based on their respective user-non-specific popularity scores and select the top 20 most highly ranked items as the user-non-specific recommendations items of the set of user-non-specific recommendation items to be presented to the user 102.

In other embodiments, after computing the user-non-specific popularity scores for items in the given set of items and prior to ranking these items based on their respective user non-specific popularity scores, the server 112 may be configured to classify these items into classes based on their respective landing pages. For example, where the server 112 analyzes the content of three landing pages, the server 112 may be configured to classify the items in the given set of items and their respective user-non-specific popularity scores into three classes, where each class is associated with a respective landing page amongst the three landing pages.

Alternatively, the server 112 may be configured to classify items into classes based on their respective topics instead of, or in addition to, classifying items into classes based on their respective landing pages. Topics of items can be, but are not limited to, sports, current affaires, pop-culture, travel and the like. Topics of items can be determined based on information associated with the respective items.

The server 112 may then be configured to rank items in each class based on their respective user-non-specific popularity scores. In other words, the server 112 may be configured to rank items of a given one of the at least one landing page based on their respective user-non-specific popularity scores amongst each other and separately from other items in the given set of items that originate from other ones of the at least landing page. The server 112 may then be configured to select at least one top ranked item from each class of items, instead of selecting the top ranked items in the given set of items, as the user-non-specific recommendation items.

Therefore, in other embodiments, such class driven selection of items allows selecting at least one item from each one of the at least one landing page of the at least one pre-determined resource. This class driven selection of items insures that the set of user-non-specific recommendation items comprises at least one user-non-specific recommendation item selected from each one of or some of the at least one landing page of the at least one pre-determined resource and, thereby increasing the likelihood of the non-personalized content recommendation to be appreciated by the user 102.

In some embodiments, the server 112 may be further configured to execute the ranking algorithm 119 of the server 112 in order to rank the user-non-specific recommendation items in the set of user-non-specific recommendation items. In other words, after selecting the user-non-specific recommendation items, the server 112 may rank the user-non-specific recommendation items via the ranking algorithm 119.

It is also contemplated that the operator of the recommendation service may consider that some types or topics of recommendation content are unsuitable for presentation to users of the recommendation service. For example, the operator may identify a “black list” that indicates types of recommendation content that are unsuitable for presentation to users of the recommendation service. Types of recommendation content that may be “black listed” comprise, but not limited to, violent content, gore content, sexually-explicit content, and the like.

In order to determine whether a given recommendation item is of a “black listed” type of recommendation content, the server 112 may be configured to receive information associated with the given recommendation item and apply a heuristic analysis thereto. If the server 112 determines that the given recommendation item is of the “black listed” type of the recommendation content, the server 112 may exclude the given recommendation item from the set of recommendation items to be presented to the user 102. Therefore, it can be said that the server 112 may also be configured to exclude at least one user-non-specific recommendation item from the set of user-non-specific recommendation items based on a given heuristic analysis.

The server 112 is also configured to generate a response data packet, such as the response 153, comprising the set of user-non-specific recommendation items. The server 112 may transmit the response 153 to the electronic device 104 via the communication network 110 for providing the user 102 with the set of user-non-specific recommendation items (non-personalized content recommendation), in lieu of the personalized content recommendation.

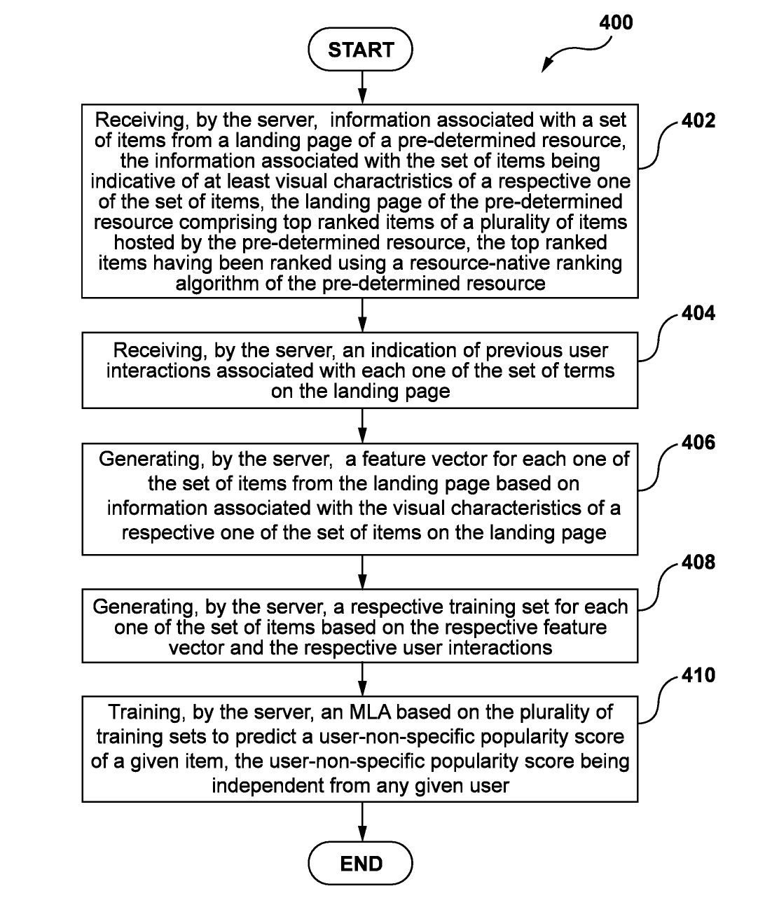

In some embodiments of the present technology, the server 112 may be configured to execute a method 400, depicted in FIG. 4, of training the first MLA 116 to predict user-non-specific popularity scores of items from landing pages of the pre-determined resources. The method 400 relates to the training phase of the first MLA 116.

Step 402: Receiving Information Associated with a Set of Items from a Landing Page of a Pre-Determined Resource

The method 400 begins at step 402 with the server 112 (see FIG. 1) receiving information associated with a given set of items from a given landing page of a given pre-determined resource. Information associated with the given set of items is indicative of at least the visual characteristics of items in the given set of items.

Generally speaking, the operator of the recommendation service hosted by the server 112 may determine a given set of pre-determined resources that she/he considers as “trustworthy” in providing content that will most likely be appreciated by new users of the recommendation service. For example, the operator of the server 112 may determine that, amongst the plurality of resources 130 (see FIG. 2), the first resource 132 and the second resource 134 are “trustworthy” resources provide content on their respective first and second landing pages 140 and 143 that will most likely be appreciated by new users.

As such, the server 112 may receive via the communication network 110 the first data packet 162 (see FIG. 1) from the first resource 132. Also, the server 112 may receive the second data packet 164 from the second resource 134. The first data packet 162 comprises (i) information associated with the first landing page 140 and (ii) indications of user interactions associated with the first landing page 140. The second data packet 164 comprises (i) information associated with the second landing page 143 and (ii) indications of user interactions associated with the second landing page 143.

It should be noted that landing pages of the pre-determined resources comprise pre-selected items of a respective plurality of items hosted by the respective pre-determined resources. Pre-selected items hosted by the respective pre-determined resources have been selected using resource-native selection algorithms of the respective pre-determined resources.

As previously mentioned, a given resource-native selection algorithm implemented by a given resource may depend on inter alia a type of items hosted by the given resource and preferences of user traffic accessing the given resource. It is contemplated that a given resource-native selection algorithm may be at least one of a software-based selection algorithm and a human-based selection algorithm.

Irrespective of the specific resource-native selection algorithms being implemented by the respective pre-determined resources, it can be said that the pre-selected items hosted by the respective pre-determined resources which are displayed on the respective landing pages comprise items that are considered as being the most relevant for the large portion of the user traffic that accesses the respective landing pages.

Recalling that the first landing page 140 hosts the set of news items 210 (see FIG. 2) being the top ranked items of the plurality of news items 200, the information associated with the first landing page 140 comprises information associated with the set of news items 210 and indications of user interactions associated with the first landing page 140 comprise indications of user interactions associated with the set of news items 210.

Also, recalling that the second landing page 143 hosts the set of retail items 230 being the top ranked items of the plurality of retail items 220, the information associated with the second landing page 143 comprises information associated with the set of retail items 230 and indications of user interactions associated with the second landing page 143 comprise indications of user interactions associated with the set of retail items 230.

In some embodiments, upon receiving the first data packets 162, the server 112 may be configured to parse the content thereof in order to extract the information associated with the visual characteristics of items in the set of news items 210. Also, upon receiving the second data packets 164, the server 112 may be configured to parse the content thereof in order to extract the information associated with the visual characteristics of items in the set of retail items 230.

Step 404: Receiving an Indication of User Interactions Associated with Each One of the Set of Items on the Landing Page

The method 400 continues to step 404 with the server 112 (see FIG. 1) receiving an indication of previous user interactions associated with each one of the set of items on the given landing page.

User interactions associated with the items originating from the first and second landing pages 140 and 143 are user interactions that have been previously performed by visitors of the first and the second resources 132 and 134 with the items on the first and second landing pages 140 and 143. Types of these user interactions are not limiting, however, just as some examples, these user interactions may be clicks, long clicks, hovering, scrolling, and other actions such as downloading, purchasing and the like.

As previously mentioned, the server 112 may receive via the communication network 110 the first data packet 162 from the first resource 132. Also, the server 112 may receive the second data packet 164 from the second resource 134. The first data packet 162 comprises (i) information associated with the first landing page 140 and (ii) indications of user interactions associated with the first landing page 140. The second data packet 164 comprises (i) information associated with the second landing page 143 and (ii) indications of user interactions associated with the second landing page 143.

In some embodiments, upon receiving the first data packets 162, the server 112 may be configured to parse the content thereof in order to extract the indications of user interactions with the set of news items 210. Also, upon receiving the second data packets 164, the server 112 may be configured to parse the content thereof in order to extract the indications of user interactions with the set of news items 230.

Step 406: Generating a Feature Vector for Each One of the Set of Items from the Landing Page

The method 400 continues to step 406 with the server 112 (see FIG. 1) being configured to generate a respective feature vector for each one of the given set of items from the respective landing pages based on the information associated with the visual characteristics of a respective one of the given set of items.

In this case, the server 112 is configured to generate a feature vector for each one of the set of news items 210 and each one of the set of retail items 230 based on the information associated with the visual characteristics a respective one of the set of news items 210 and with a respective one of the set of retail items 230.

In some embodiments of the present technology, the server 112 may be configured to store for each item amongst the set of news items 210 and the set of retail items 230 the respective feature vector in the main database 120 (see FIG. 1) for further use thereof.

Each feature vector is generated by the server 112 based on the information associated with the visual characteristics of a respective item. The visual characteristics of a given item may comprise, but are not limited to, a position of the given item on the respective landing page, a size of the given item on the respective landing page, a relative size of the given item with respect to other items on the respective landing page, a presence of an image and/or of a video associated with the given item on the respective landing page, fonts of textual information associated with the given item on the respective landing page, and the like.

In other embodiments of the present technology, a given feature vector may be generated, not only based on the information associated with the visual characteristics of a respective item, but also based on other information associated with the respective item without departing from the scope of the present technology. Therefore, in other embodiments of the present technology, a given feature vector may be based at least on the information associated with the visual characteristics of a respective item.

At least some dimensions of a given feature vector are associated with visual characteristics of a respective item on the respective landing page. For example, at least one dimension of the given feature vector may be associated with a first visual characteristic of the respective item such as the size thereof on the respective landing page, while at least one other dimension of the given feature vector may be associated with another visual characteristic of the respective item such as the position thereof on the respective landing page.

Step 408: Generating a Training Set for Each One of the Set of Items from the Landing Page

The method 400 then continues to step 408 with the server 112 being configured to generate a respective training set for each one of the set of items based on the respective feature vector and the respective user interactions of the respective one of the set of items on the respective landing page.

In this case, the server 112 is configured to generate a respective training set for each one of the set of news items 210 and each one of the set of retail items 230 contains the respective feature vectors and the respective item-interaction data having been extracted from the content of the first and the second data packets 162 and 164.

In other words, the server 112 is configured to generate for each item a respective training set contains (i) a respective feature vector previously generated and (ii) the respective item-interaction data, as depicted in FIG. 3.

In some embodiments of the present technology, the server 112 may be configured to store for each item amongst the set of news items 210 and the set of retail items 230 the respective training set in the main database 120 (see FIG. 1) for further use thereof.

### Step 410: Training an MLA Based on the Plurality of Training Sets to Predict a User-Non-Specific Popularity Score of a Given Item

The method 400 ends at step 410 with the server 112 being configured to train the first MLA 116 based on a plurality of training sets to predict a user-non-specific popularity score of a given item. A given user-non-specific popularity score is independent from any given user.

In this case, the server 112 is configured to input the training sets 361, 362 363, 364, 365, 366 and 367 into the “untrained” first MLA 116 in order to train the first MLA 116 to predict user-non-specific popularity scores of given items.

In other words, the “untrained” first MLA 116 learns, in a sense, relationships and/or data patterns between the visual characteristics of given items on their respective landing pages and their respective user interactions in order to approximate how visual characteristics of the given items “correlate” to user interactions with these items on their respective landing pages.

The first MLA 116 may “learn” that the amount of user interactions with given items on the respective landing pages, at least in some cases, may grow with the respective sizes thereof on the respective landing pages. The first MLA 116 may “learn” that the amount of user interactions with given items on the respective landing pages, at least in some cases, may grow in-line with the higher positions thereof on the respective landing pages. The first MLA 116 may “learn” how each given visual characteristic of a given item influences the amount of user interactions with the given item on the respective landing page.

In some embodiments, the server 112 may be configured to predict, by employing the “trained” first MLA 116, a given user-non-specific popularity score of a new item originating from a given landing page of a given pre-determined resource as previously explained by means of examples presented above.

It is also contemplated that the server 112 may be configured to predict, by employing the “trained” first MLA 116, a given user-non-specific popularity score of another new item originating from a given landing page of a newly pre-determined resource. A given newly pre-determined resource refers to a given pre-determined resource that has not been used during the training phase of the first MLA 116 and/or that has not been determined as a “trustworthy” resource prior to execution the training phase of the first MLA 116.

In other embodiments, the server 112 may be configured to determine whether a given new item is to be recommended to the user 102 based on the user non-specific popularity score of the given new item. In other words, the server 112 may be configured to determine whether the given new item is to be selected as a given user-non-specific recommendation item for provision to the user 102 as previously explained by means of examples presented above.

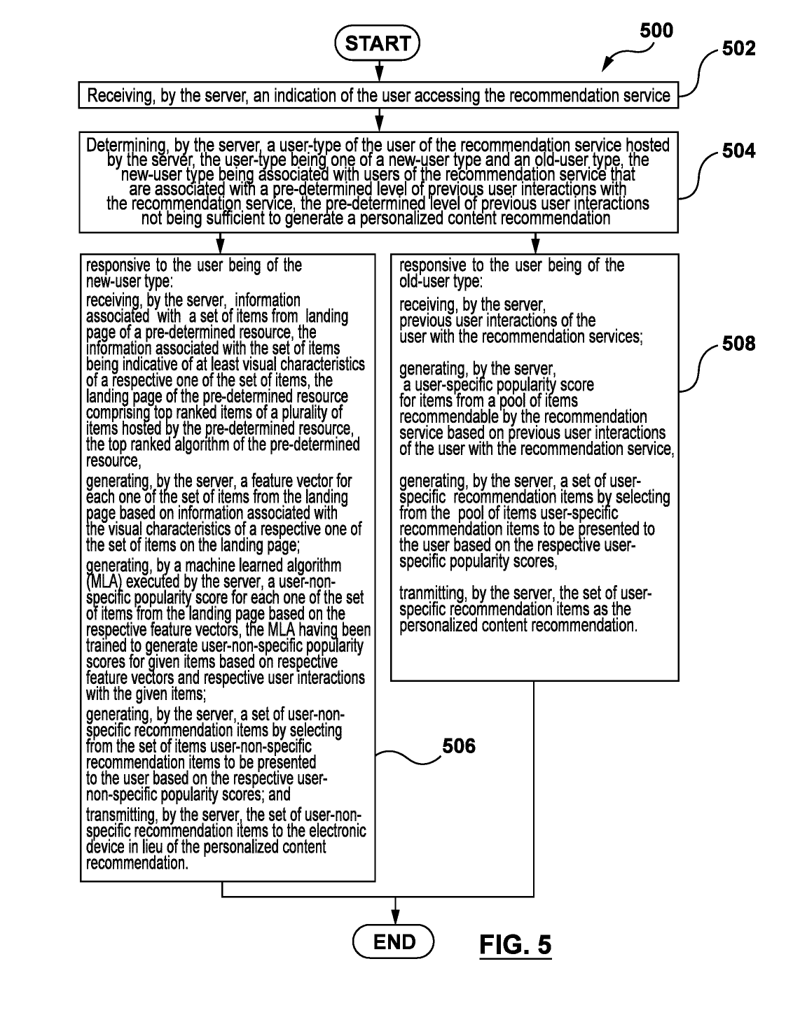

With reference to FIG. 5, the server 112 may be configured to execute a method 500 of selecting given recommendation items to be transmitted to the electronic device 104 associated with the user 102 of the recommendation service. The method 500 will now be described in further detail herein below.

### Step 502: Receiving an Indication of the User Accessing the Recommendation Service

The method 500 begins at step 502 with the server 112 receiving an indication of the user 102 accessing the recommendation service hosted thereby.

In some embodiments of the present technology, the request 150 may be generated in response to the user 102 providing an explicit indication of the user desire to receive recommended content such as by clicking a button from the recommendation application 106. Therefore, the request 150 for a given set of recommendation items can be thought of as “an explicit request” in a sense of the user 102 expressly providing a request for the given set of recommendation items.

In other embodiments, the request 150 can be generated in response to the user 102 providing an implicit indication of the user desire to receive recommended content. In some embodiments of the present technology, the request 150 can be generated in response to the user 102 starting the recommendation application 106.

In yet further embodiments of the present technology, the request 150 can be generated even without the user 102 providing either explicit or implicit indication of the user desire to receive recommended content.

### Step 504: Determining a User-Type of the User of the Recommendation Service

The method 500 then continues to step 502 with the server 112 determining the user-type of the user 102 of the recommendation service. The user-type can be one of a new-user type and an old-user type. The new-user type is associated with users of the recommendation service that are associated with a given pre-determined level of previous user interactions with the recommendation service that is not sufficient to generate a personalized content recommendation.

It is contemplated that, in some embodiments of the present technology, the server 112 may be configured to selectively execute different routines depending on whether the user 102 is of the new-user type or of the old-user type in order to recommend items to the user 102.

Upon execution of the user-type determination algorithm 114, the server 112 is configured to receive information associated with previous user interactions associated with the user 102 from the user interaction database 126.

It is contemplated that upon receiving the information associated with previous user interactions associated with the user 102 from the interaction database 126, the server 112 may store the information associated with previous user interactions associated with the user 102 in the main database 120 for further use thereof.

The server 112 is also configured to determine whether or not the user 102 is associated with the pre-determined level of previous user interactions. Depending on whether the amount of previous user interactions of the user 102 with the recommendation service does or does not correspond to the pre-determined level of previous user interactions, the server 112 will determine whether the user 102 is of the new-user type or the old-user type, respectively, and, consequently, will selectively execute various routines for providing the user 102 with recommendation content.

The method 500 can continue to step 506 or to step 508 depending on the user-type of the user 102.

Step 506: Selective Execution of a Routine Responsive to the User being of the New-User Type

The method 500 can end at the step 506 where, responsive to the user 102 being of the new-user type, the server 112 selectively executes a first routine for transmitting user-non-specific recommendation content to the user 102.

As part of the first routine (i.e., responsive to the user being of the new-user type), the server 112 receives information associated with a given set of items from a given landing page of a given pre-determined resource. Put another way, the server 112 receives information associated with at least one landing page of at least one pre-determined resource that has been previously determined by the operator of the recommendation service as a “trustworthy” resource.

In some embodiments, the server 112 may be configured to receive information associated with the first landing page 140 of the first resource 132 and/or the second landing page 143 of the second resource 134. However, it is contemplated that the server 112 may be configured to receive information associated with any other landing page of any other resource that has been previously determined by the operator of the recommendation service as a “trustworthy” resource.

It should be noted that the at least one landing page of the at least one pre-determined resources comprises pre-selected items of a respective plurality of items hosted by the respective pre-determined resources. Pre-selected items hosted by the at least one pre-determined resource have been selected using at least one resource-native selection algorithm of the at least one pre-determined resource.

As previously mentioned, a given resource-native selection algorithm implemented by a given resource may depend on inter alia a type of items hosted by the given resource and preferences of visitors accessing the given resource. It is contemplated that the given resource-native selection algorithm may be at least one of a software-based selection algorithm and a human-based selection algorithm.

Irrespective of the specific resource-native selection algorithms being implemented by the at least one pre-determined resource, it can be said that the respective pre-selected items hosted by the at least one pre-determined resource which are displayed on the respective at least one landing page comprise items that are considered as being the most relevant for the large portion of the user traffic that accesses the respective at least one landing page.

For example, the server 112 may receive information associated with the at least one landing page of the at least one pre-determined resource. This information comprises the information associated with a given set of items on the at least one landing page. The information associated with the given set of items is indicative of visual characteristics of each one of the given set of items. The server 112 may parse the information associated with the given set of items in order to extract the information associated with the visual characteristics of each one of the given set of items.

As part of the first routine (i.e., responsive to the user being of the new-user type), the server 112 generates a respective feature vector for each one of the given set of items of the at least one landing page. The server 112 can generate a respective feature vector for each one of the given set of items of the at least one landing page similarly to how the server 112 is configured to generate the feature vectors 351, 352, 353, 354, 355, 356 and 357.

As previously mentioned, each feature vector of each one of the given set of items of the at least one landing page is generated based on the information associated with the visual characteristics of the respective item on the respective one of the at least one landing page.

Alternatively, each feature vector of each one of the given set of items of the at least one landing page is based at least on the visual characteristics of the respective item on the respective one of the at least one landing page.

It is contemplated that the server 112 may store each feature vector of each one of the given set of items of the at least one landing page in association with the information indicative of a respective item amongst the given set of items in the main database 120 for further use thereof.

As part of the first routine (i.e., responsive to the user being of the new-user type), the server 112 generates a respective user-non-specific popularity score for each one of the set of items from the at least one landing page based on the respective feature vectors. The server 112 employs the “trained” first MLA 116 in order to generate these user-non-specific popularity scores. The “trained” MLA 116 employed by the server 112 can be trained according to various embodiments of the method 400 (see FIG. 4).

For example, if the given set of items of the at least one landing page comprises 25 items, the server 112 may be configured to generate 25 user-non-specific popularity scores where each user-non-specific popularity score is associated with a respective item.

As part of the first routine (i.e., responsive to the user being of the new-user type), the server 112 generates a given set of user-non-specific recommendation items by selecting from the given set of items at least one user-non-specific recommendation item to be presented to the user 102 based on the respective user-non-specific popularity scores.

In one embodiments of the present technology, the server 112 may be configured to rank the items in the given set of items based on their respective user-non-specific popularity scores and may select the top ranked items as the user-non-specific recommendation items.

For example, the server 112 may rank the 25 items based on their respective user-non-specific popularity scores and select the top 20 most highly ranked items as the user-non-specific recommendations items of the set of user-non-specific recommendation items to be presented to the user 102.

In another embodiment of the present technology, after computing the user-non-specific popularity scores for items in the given set of items and, instead of ranking all these items amongst each other based on their respective user non-specific popularity scores, the server 112 may be configured to classify these items into classes based on their respective landing pages.

For example, if the at least one landing page comprises three landing pages, the server 112 may be configured to classify the items in the given set of items and their respective user-non-specific popularity scores into three classes, where each class is associated with a respective landing page amongst the three landing pages.

Therefore, in the another embodiment, the server 112 may rank items in each class based on their respective user-non-specific popularity scores. In other words, the server 112 may be configured to rank items of a given one of the at least one landing page based on their respective user-non-specific popularity scores amongst each other and separately from other items in the given set of items that originate from other ones of the at least landing page. The server 112 may then select at least one top ranked item from each class of items, instead of selecting the top ranked items in the given set of items, as the user-non-specific recommendation items.

Therefore, in the other embodiment, such class driven selection of items allows selecting at least one item from each one of the at least one landing page of the at least one pre-determined resource. This class driven selection of items insures that the set of user-non-specific recommendation items comprises at least one user-non-specific recommendation item selected from each one of the at least one landing page of the at least one pre-determined resource.

Therefore, generation of the given set of user-non-specific recommendation items may comprise the server 112 (i) classifying items in the given set of items and their respective user-non-specific popularity scores from the at least one landing page into a plurality of distinct landing page classes, (ii) ranking items in each one of the plurality of distinct landing pages classes based on their respective user-non-specific popularity scores and (iii) selecting from at least a portion of the plurality of distinct landing page classes at least one top ranked item as the at least one user-non-specific recommendation item to be presented to the user 102.

In additional embodiments, the server 112 may be further configured to execute the ranking algorithm 119 of the server 112 in order to rank user-non-specific recommendation items in the given set of user-non-specific recommendation items. In other words, after selecting the user-non-specific recommendation items, the server 112 may rank the user-non-specific recommendation items via the ranking algorithm 119.

In further embodiments, server 112 may exclude at least one user-non-specific recommendation item from the set of user-non-specific recommendation items based on a given heuristic analysis.

For example, the operator of the recommendation service hosted by the server 112 may identify a “black list” comprising types and/or topics of recommendation content that are unsuitable for presentation to users of the recommendation service. Types of recommendation content that may be “black listed” comprise, but not limited to, violent content, gore content, sexually-explicit content, and the like.

In order to determine whether a given user-non-specific recommendation item is of a “black listed” type of recommendation content, the server 112 may retrieve information associated with the given user-non-specific recommendation item and apply the given heuristic analysis thereto. If the server 112 determines that the given user-non-specific recommendation item is of the “black listed” type of the recommendation content, the server 112 may exclude the given user-non-specific recommendation item from the given set of recommendation items to be presented to the user 102.

As part of the first routine (i.e., responsive to the user being of the new-user type), the server 112 transmits the given set of user-non-specific recommendation items to the electronic device 104 (see FIG. 1) in lieu of the personalized content recommendation.

Step 508: Selective Execution of a Routine Responsive to the User being of the Old-User Type

The method 500 can end at the step 508 where, responsive to the user 102 being of the old-user type, the server 112 selectively executes a second routine for transmitting user-specific recommendation content to the user 102.

As part of the second routine (i.e., responsive to the user being of the old-user type), the server 112 receives information associated with previous user interactions of the user 102 with the recommendation service. In one implementation of the present technology, the server 112 may retrieve the information associated with the previous user interactions associated with the user 102 from the user interaction database 126 (see FIG. 1). In another implementation of the present technology, the server 112 may retrieve the information associated with the previous user interactions associated with the user 102 from the main database 120.

It should be noted that by the time the server 112 selectively executes the second routine, the server 112 may have already retrieved, during the step 504, the information associated with the previous user interactions associated with the user 102 for determining the user-type of the user 102. As such in other implementations of the present technology, the server 112 may not require re-receiving the information associated with the previous user interactions associated with the user 102 during the execution of the second routine and, instead, may “fetch” from its own computer usable information storage medium (not depicted), such as RAM, the information associated with the previous user interactions associated with the user 102.

As part of the second routine (i.e., responsive to the user being of the old-user type), the server 112 generates user-specific popularity scores for at least some items from the pool of potentially recommendable items stored in the recommendable item database 124 based on the previous user interactions of the user 102. The server 112 may employ the second MLA 118 for generating a user-specific popularity score for the at least some items of the pool of potentially recommendable items stored in the recommendable item database 124.

To that end, the server 112 retrieves information associated with the at least some items of the pool of potentially recommendable items from the recommendable item database 124 and item features associated with the at least some items of the pool of potentially recommendable items from the item features database 122.

The server 112 inputs (i) the information associated with the at least some items of the pool of potentially recommendable items, (ii) the item features associated with the at lease some items of the pool of potentially recommendable items and (iii) the information associated with the previous user interactions associated with the user 102, into the second MLA 118 for generating a respective user-specific popularity score for each one of the at least some items of the pool of potentially recommendable items.

In this case, the user-specific popularity scores are “user-specific” to the user 102 since they were generated at least in part based on the previous user interactions associated with the user 102.

The second MLA 118 may also select top ranked items amongst the at least some items of the pool of potentially recommendable items based on the user-specific popularity scores as user-specific recommendation items to be presented to the user 102.

It is contemplated that the server 112 may be further configured to execute the ranking algorithm 119 in order to rank user-specific recommendation items in the given set of user-specific recommendation items. In other words, after selecting the user-specific recommendation items, the server 112 may rank the user-specific recommendation items via the ranking algorithm 119.

The server 112 then transmits the set of user-specific recommendation items as the personalized content recommendation to the electronic device 104 for presentation to the user 102 via the recommendation application 106.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of selecting recommendation items to be transmitted to an electronic device associated with a user of a recommendation service, the recommendation service being hosted by a server, the method executable at the server, the method comprising:
receiving, by the server, an indication of the user accessing the recommendation service;
determining, by the server, a user-type of the user of the recommendation service hosted by the server, the user-type being one of a new-user type and an old-user type, the new-user type being associated with users of the recommendation service that are associated with a pre-determined level of previous user interactions with the recommendation service, the pre-determined level of previous user interactions not being sufficient to generate a personalized content recommendation;
responsive to the user being of the new-user type:
receiving, by the server, information associated with a set of items from a landing page of a pre-determined resource, the information associated with the set of items being indicative of at least visual characteristics of a respective one of the set of items, the landing page of the pre-determined resource comprising pre-selected items of a plurality of items hosted by the pre-determined resource;
generating, by the server, a feature vector for each one of the set of items from the landing page based on information associated with the visual characteristics of a respective one of the set of items on the landing page;
generating, by a machine learned algorithm (MLA) executed by the server, a user-non-specific popularity score for each one of the set of items from the landing page based on the respective feature vectors, the MLA having been trained to generate user-non-specific popularity scores for given items based on respective feature vectors and respective user interactions with the given items;
generating, by the server, a set of user-non-specific recommendation items by selecting from the set of items user-non-specific recommendation items to be presented to the user based on the respective user-non-specific popularity scores; and
transmitting, by the server, the set of user-non-specific recommendation items to the electronic device in lieu of the personalized content recommendation.

2. The method of claim 1, wherein:
responsive to the user being of the old-user type:
receiving, by the server, previous user interactions of the user with the recommendation service;
generating, by the server, a user-specific popularity score for items from a pool of items recommendable by the recommendation service based on the previous user interactions of the user with the recommendation service;
generating, by the server, a set of user-specific recommendation items by selecting from the pool of items user-specific recommendation items to be presented to the user based on the respective user-specific popularity scores; and
transmitting, by the server, the set of user-specific recommendation items as the personalized content recommendation.

3. The method of claim 1, wherein the method further comprises extracting, by the server, the information associated with the visual characteristics of each one of the set of items from the information associated with the set of items.

4. The method of claim 1, wherein the user-non-specific recommendation items comprise news items.

5. The method of claim 1, wherein the pre-selected items have been selected using a resource-native selection algorithm of the pre-determined resource.

6. The method of claim 5, wherein the resource-native selection algorithm is at least one of a software-based selection algorithm and a human-based selection algorithm.

7. The method of claim 5, wherein the ranking algorithm of the pre-determined resource ranks the plurality of items based on freshness of each of the plurality of items.

8. The method of claim 1, wherein the visual characteristics comprise at least one of:
position of the given item on the landing page;
size of the given item on the landing page; and
presence of an image associated with the given item on the landing page.

9. The method of claim 1, where the visual characteristics are indicative of a prominence of a respective item on the respective landing page for an operator of the respective resource.

10. The method of claim 1, wherein the generating the set of user-non-specific recommendation items comprises ranking, by the server, the user-non-specific recommendation items in the set of user-non-specific recommendation items based on a ranking algorithm of the recommendation service.

11. The method of claim 1, wherein the generating the set of user-non-specific recommendation items comprises excluding, by the server, at least one user-non-specific recommendation item from the set of user-non-specific recommendation items based on a heuristic analysis.

12. The method of claim 11, wherein the excluding the at least one user-non-specific recommendation item from the set of user-non-specific recommendation items based on the heuristic analysis comprises determining, by the server, that the at least one user-non-specific recommendation item comprises at least one of:
violent content;
gore content; and
sexually-explicit content.

13. A method of training a machine learned algorithm (MLA) to predict user-non-specific popularity scores of items for a user of a recommendation service, the recommendation service being hosted by a server, the user being of a new-user type, the new-user type being associated with users of the recommendation service that are associated with a pre-determined level of previous user interactions with the recommendation service, the pre-determined level of previous user interactions not being sufficient to generate a personalized user content recommendation, the server implementing the MLA, the method comprising:
receiving, by the server, information associated with a set of items from a landing page of a pre-determined resource, the information associated with the set of items being indicative of at least visual characteristics of a respective one of the set of items, the landing page of the pre-determined resource comprising pre-selected items of a plurality of items hosted by the pre-determined resource;
receiving, by the server, an indication of previous user interactions associated with each one of the set of items on the landing page;
generating, by the server, a feature vector for each one of the set of items from the landing page based on information associated with the visual characteristics of a respective one of the set of items on the landing page;
generating, by the server, a respective training set for each one of the set of items based on the respective feature vector and the respective user interactions; and
training, by the server, an MLA based on the plurality of training sets to predict a user-non-specific popularity score of a given item, the user-non-specific popularity score being independent from any given user.

14. The method of claim 13, wherein the method further comprises predicting, by the MLA implemented by the server, the user-non-specific popularity score of a new item.

15. The method of claim 14, wherein the method further comprises determining, by the server, whether the new item is to be recommended to the user based on the user non-specific popularity score of the new item.

16. A server for selecting recommendation items to be transmitted to an electronic device associated with a user of a recommendation service, the recommendation service being hosted by the server, the server being configured to:
receive an indication of the user accessing the recommendation service;
determine a user-type of the user of the recommendation service, the user-type being one of a new-user type and an old-user type, the new-user type being associated with users of the recommendation service that are associated with a pre-determined level of previous user interactions with the recommendation service, the pre-determined level of previous user interactions not being sufficient to generate a personalized content recommendation;
responsive to the user being of the new-user type:
receive information associated with a set of items from a landing page of a pre-determined resource, the information associated with the set of items being indicative of at least visual characteristics of a respective one of the set of items, the landing page of the pre-determined resource comprising pre-selected items of a plurality of items hosted by the pre-determined resource;
generate a feature vector for each one of the set of items from the landing page based on information associated with the visual characteristics of a respective one of the set of items on the landing page;
generate, by employing a machine learned algorithm (MLA), a user-non-specific popularity score for each one of the set of items from the landing page based on the respective feature vectors, the MLA having been trained to generate user-non-specific popularity scores for given items based on respective feature vectors and respective user interactions with the given items;
generate a set of user-non-specific recommendation items by selecting from the set of items user-non-specific recommendation items to be presented to the user based on the respective user-non-specific popularity scores; and
transmit the set of user-non-specific recommendation items to the electronic device in lieu of the personalized content recommendation.

17. The server of claim 16, wherein:
responsive to the user being of the old-user type:
receive previous user interactions of the user with the recommendation service;
generate a user-specific popularity score for items from a pool of items recommendable by the recommendation service based on the previous user interactions of the user with the recommendation service;
generate a set of user-specific recommendation items by selecting from the pool of items user-specific recommendation items to be presented to the user based on the respective user-specific popularity scores; and
transmit the set of user-specific recommendation items as the personalized content recommendation.

18. The server of claim 16, wherein the server is further configured to extract the information associated with the visual characteristics of each one of the set of items from the information associated with the set of items.

19. The server of claim 16, wherein the set of user-non-specific recommendation items comprises news items.

20. The server of claim 16, wherein the pre-selected items have been selected using a resource-native selection algorithm of the pre-determined resource.
